(19) United States
(12) Patent Application Publication
(10) Pub. No.: US 2025/0215650 A1
(43) Pub. Date: Jul. 3, 2025

(54) HEATING CABLE SUPPORT ASSEMBLY

(71) Applicant: Thermic Solutions, LLC, Etna, WY (US)

(72) Inventors: Brandon J. HAWKINS, Arvada, CO (US); Charles B. CLOTIAUX, Edgewater, CO (US); Bart A. WILDE, Heber City, UT (US); Eric W. BUTLER, Etna, WY (US)

(73) Assignee: Thermic Solutions, LLC, Etna, WY (US)

(21) Appl. No.: 19/007,755

(22) Filed: Jan. 2, 2025

Related U.S. Application Data
(60) Provisional application No. 63/617,017, filed on Jan. 2, 2024.

(51) Int. Cl. E01C 11/26; E01C 5/00; F16L 3/06; F16L 3/21

(52) U.S. Cl. CPC E01C 11/26; F16L 3/06; F16L 3/21; E01C 5/001

(57) ABSTRACT

A support assembly described herein may include a variable height coupler, a base coupled to a first end of the variable height coupler, and a rail coupled to a second end of the variable height coupler. The variable height coupler may include a spring biased to separate the base from the rail.

### CROSS REFERENCE TO RELATED PATENT APPLICATION

This application is a continuation application claiming benefit of U.S. Provisional Application No. 63/617,017, titled “Paver Pedestal,” filed Jan. 2, 2024, which is hereby incorporated by reference in its entirety.

### TECHNICAL FIELD

The present disclosure relates generally to pedestals for use in connection with pavers or similar architectural elements. Specifically, the present disclosure relates to systems and methods for a contact-biased system for maintaining contact between a heating element and the architectural elements via use of variable height coupler(s) of heating cable support assemblies.

### BACKGROUND

Many commercial and residential properties include surfaces on which individuals may be allowed to walk or drive. Further, many infrastructure elements such as electrical wiring, communication wiring, pipes, heating, ventilation, and air conditioning (HVAC) systems and other utilities may be incorporated underneath an overlaying surface(s) of those walkable and drivable areas. In some instances, the overlaying surface may include raised surface elements such as pavers, tiles, or other infrastructure elements incorporated into the commercial and residential properties to ensure that these utilities are protected from weather and provide a leveled or sloped overlaying surface with respect to an intended orientation or maintained in an intended position. For example, pavers may be raised or elevated from a subsurface or substructure to provide a level surface and access to utilities that may be placed under the raised flooring. The raised surface may be utilized in driveways, patios, walkways, decks, rooftops and other architectural surfaces. Further, these architectural surfaces may be located within a structure such as a building either on rooftops or at grade.

The raising of the surface may be accomplished by placing stanchions under the pavers, tiles, or other architectural elements. In this state, however, air currents and negative space under the raised surfaces may cause a decrease in temperatures between a subsurface on which the stanchions and the architectural elements are seated and the architectural elements themselves. In other words, there would exist no thermal conductivity between the subsurface and the architectural elements. This may lead to an inability to clear precipitation including snow and ice since no thermal conductivity may be achieved between a heating device that may be place beneath the architectural elements or even the subsurface or substructure on which the raised surfaces are positioned. With the inability to, for example, melt snow and ice from the surface of the architectural elements, an increase in accidents and harm to individuals and property may increase.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a top perspective view of a heating cable support assembly (HCSA), according to an example of the principles described herein.

FIG. 2 illustrates a bottom perspective view of the HCSA of FIG. 1, according to an example of the principles described herein.

FIG. 3 illustrates a top perspective view of a paver system incorporating the HCSA of FIGS. 1 and 2, according to an example of the principles described herein.

FIG. 4 illustrates a bottom perspective view of a paver system incorporating the HCSA of FIGS. 1 and 2, according to an example of the principles described herein.

FIG. 5 illustrates a top plan view of a paver system incorporating the HCSA of FIGS. 1 and 2, according to an example of the principles described herein.

FIG. 6 illustrates a cutaway side view of the paver system about the line A of FIG. 5, according to an example of the principles described herein.

FIG. 7 illustrates a cutaway view of the paver system about the circle B of FIG. 4, according to an example of the principles described herein.

FIG. 8 illustrates a top perspective view of a HCSA, according to an example of the principles described herein.

FIG. 9 illustrates a top plan view of the HCSA of FIG. 8, according to an example of the principles described herein.

FIG. 10 illustrates a side plan view of the HCSA of FIG. 8, according to an example of the principles described herein.

FIG. 11 illustrates a top perspective view of a HCSA, according to an example of the principles described herein.

FIG. 12 illustrates a top plan view of the HCSA of FIG. 11, according to an example of the principles described herein.

FIG. 13 illustrates a side plan view of the HCSA of FIG. 11, according to an example of the principles described herein.

FIG. 14 illustrates a top perspective view of a HCSA, according to an example of the principles described herein.

FIG. 15 illustrates a top plan view of the HCSA of FIG. 14, according to an example of the principles described herein.

FIG. 16 illustrates a side plan view of the HCSA of FIG. 14, according to an example of the principles described herein.

FIG. 17 illustrates a side plan view of two of the HCSAs of FIG. 14 coupled together, according to an example of the principles described herein.

FIG. 18 illustrates a cutaway view of the two HCSAs of FIG. 17 about the circle C of FIG. 17, according to an example of the principles described herein.

### DESCRIPTION OF EXAMPLE EMBODIMENTS

### Overview

This disclosure describes a heating cable support assembly (HCSA) for use in raised surface including architectural elements that are raised onto stanchions. The HCSA may be used to ensure direct contact or an intended juxtaposition of a device such as, for example, a heating element or heating cable relative to the architectural elements such as, for example, pavers or tiles that are included within the raised surface. The HCSA may include variable height coupler(s) is able to adjust the height of a rail of the HCSA to keep the device in contact with the architectural elements. In use, the device may be placed on top of the rail and the device is pressed into the architectural elements via the variable height coupler(s).

In one example, the variable height coupler may be a spring that passively adjusts the height of the rail of the HCSA to maintain physical contact between the architectural elements and a surface of the device (e.g., a heating element). In other examples, the variable height coupler may include a pneumatic piston, a hydraulic piston, a magnet, a mechanical device such as a lever arm biased in a first direction and that yields when a force is meant, other types of devices used to bias the increase of the distance between the base(s) coupled to a first end of the variable height coupler and the rail coupled to a second end of the variable height coupler, and combinations thereof. In other words, the variable height coupler may include any device that causes the distance between the base(s) and the rail to be biased to increase such that the rail is able to force the device towards and/or to abut the architectural element and may utilize any force such as, for example, a mechanical force, a pneumatic force, a hydraulic force, a magnetic force, other types of forces and combination thereof.

Examples described herein provide an HCSA including a variable height coupler, a base coupled to a first end of the variable height coupler, and a rail coupled to a second end of the variable height coupler. The variable height coupler may include a spring biased to separate the base from the rail. The variable height coupler may be biased to separate the base from the rail based on at least one of a mechanical force, a pneumatic force, a hydraulic force, and a magnetic force. The variable height coupler may include a yielding lever arm coupled between the base and the rail. The variable height coupler may be monolithically formed with the base, the rail, and/or combinations thereof.

The rail may include a slot defined therein. The slot may include a retention catch formed on the slot. The HCSA may further include an annular void defined in the base. The HCSA may further include a protrusion formed on the rail to couple the variable height coupler to the rail. The HCSA may further include a coupler interface to couple the protrusion to the variable height coupler.

Examples described herein also provide a paver system including a paver, and a stanchion to elevate the paver above a subsurface. The paver system may further include a HCSA to maintain contact between an element and the paver. The HCSA may include a variable height coupler, a base coupled to a first end of the variable height coupler, and a rail coupled to a second end of the variable height coupler. The element may include a heating element.

The variable height coupler may include a spring biased to separate the base from the rail. The variable height coupler may be biased to separate the base from the rail based on at least one of a mechanical force, a pneumatic force, a hydraulic force, and a magnetic force. The variable height coupler may include a yielding lever arm coupled between the base and the rail. The variable height coupler may be monolithically formed with the base, the rail, and/or combinations thereof.

The rail may include a slot defined therein, and a retention catch formed on the slot. The paver system may further include a mounting hole defined in the base. The paver system may further include a protrusion formed on the rail to couple the variable height coupler to the rail. The paver system may further include a coupler interface to couple the protrusion to the variable height coupler.

As used in the present specification and in the appended claims, the term “engineering fit” is meant to be understood broadly as any fit or clearance between two mating parts. The size of this clearance determines whether the parts can, at one end of the spectrum, move or rotate independently from each other or, at the other end, are temporarily or permanently joined together. Thus, an engineering fit may include, for example, a clearance fit (e.g., one of a loose running fit, a free running fit, a close running fit, a sliding fit, and a location fit), a transition fit (e.g., one of a similar fit, and a fixed fit), an interference fit (e.g., one of a press fit, a driving fit, and a forced fit), or other type of engineering fit.

### EXAMPLE EMBODIMENTS

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

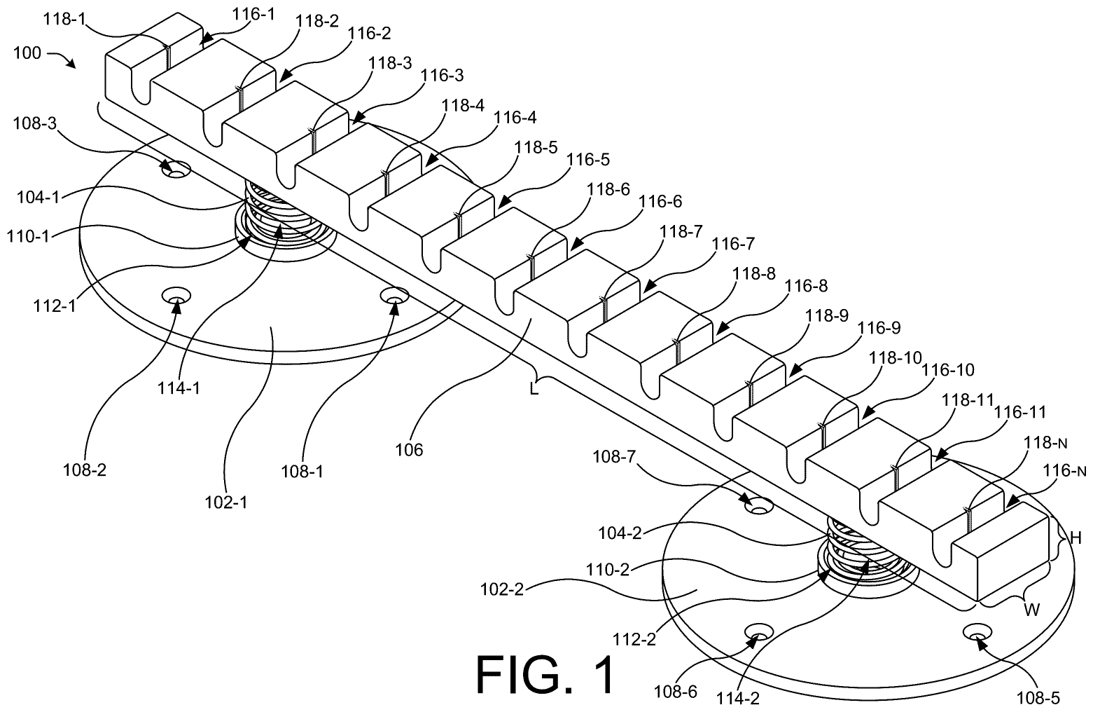

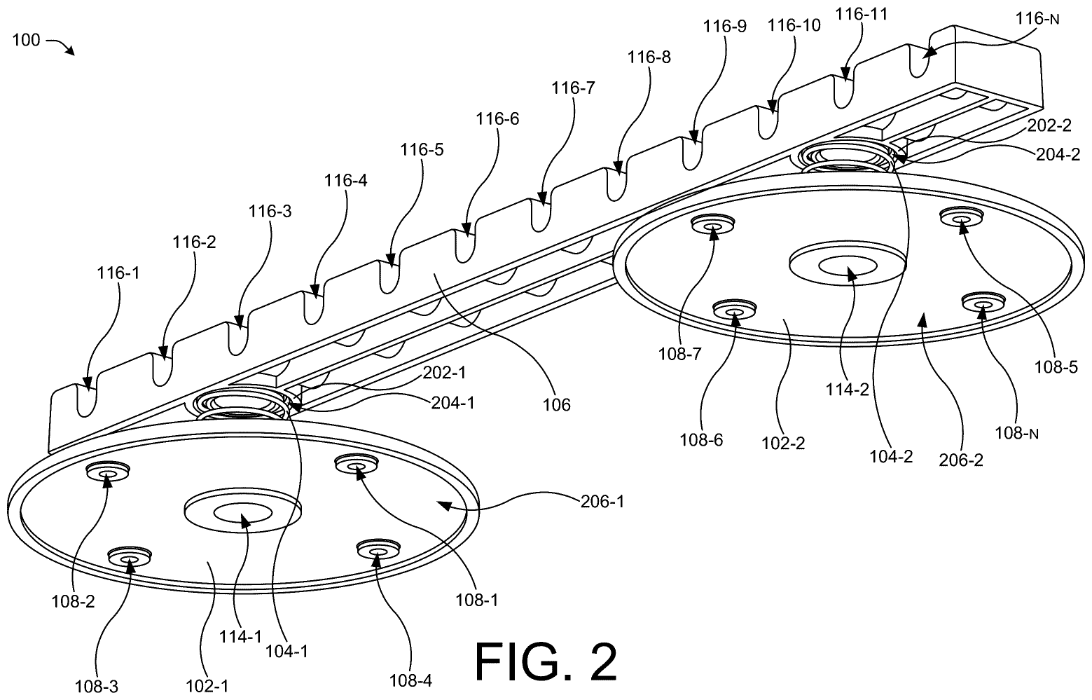

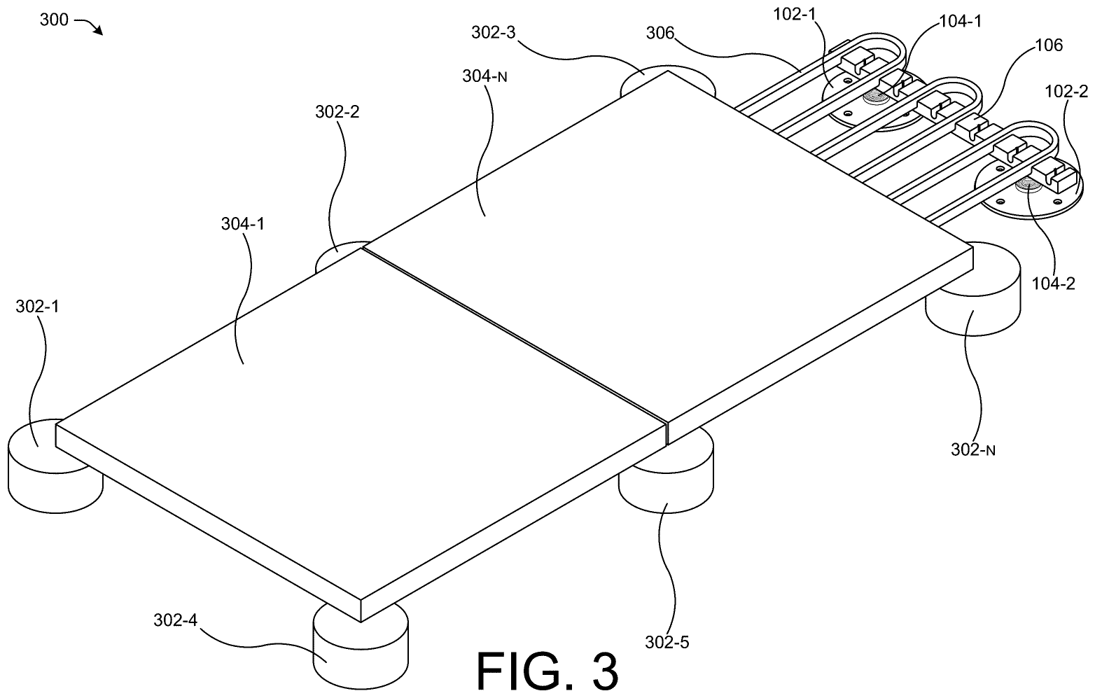

FIG. 1 illustrates a top perspective view of a heating cable support assembly (HCSA) 100, according to an example of the principles described herein. FIG. 2 illustrates a bottom perspective view of the HCSA 100 of FIG. 1, according to an example of the principles described herein. The HCSA 100 as described herein may be used to maintain physical contact or juxtaposition of a device (FIG. 3, 306) such as a heating element with an architectural element (FIG. 3, 304) such as a paver, a tile, or other raised surface materials. In one example, at least one HCSA 100 may be positioned or located underneath one or more architectural elements (FIG. 3, 304) in order to heat the raised architectural element (FIG. 3, 304). This may be especially useful in situations where precipitation may be melted and/or evaporated off the surface of the architectural element (FIG. 3, 304) that is opposite the side of the architectural element (FIG. 3, 304) where the HCSA 100 and the device (FIG. 3, 306) are located.

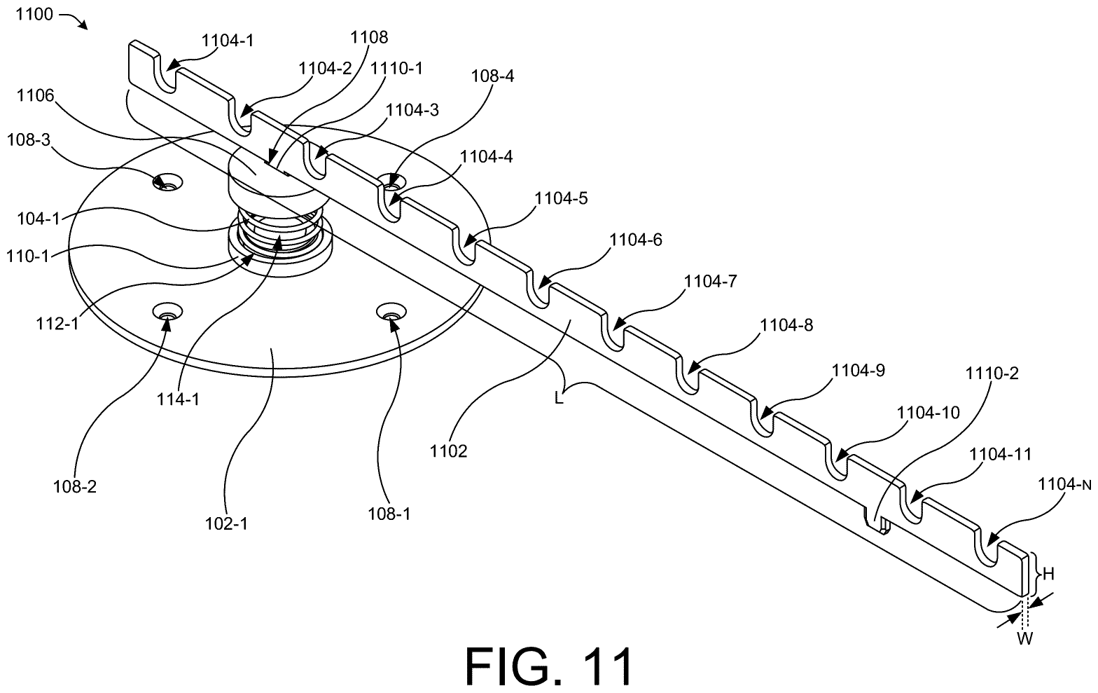

In order to achieve the above-referenced physical contact or juxtaposition of the device (FIG. 3, 306) as to the architectural element (FIG. 3, 304), the HCSA 100 may include a first base 102-1 and a second base 102-2 (collectively referred to herein as base(s) 102 unless specifically addressed otherwise). Although two bases 102 are depicted in FIGS. 1 through 10, any number of base(s) 102 may be included and the elements of the HCSA 100 described herein that are associated with the addition of base(s) 102 may also be included. The example of the HCSA 1100 as depicted in FIGS. 11 through 13 include a single base 102. However, the example of the HCSA 1100 as depicted in FIGS. 11 through 13 may include at least one additional base(s) 102 as will be described in more detail below. In one example, the bases 102 may have a diameter of between 3 inches (in.) (e.g., 76.2 millimeters (mm)) and 5 in. (e.g., 127 mm). In one example, the bases 102 may have a diameter of approximately 4.0 in. (e.g., 101.6 mm).

The base(s) 102 may be made of any rigid material that may support the pressures applied to the base(s) 102 by the opposing forces described herein. For example, the base(s) 102 may be made of plastics, woods, metals, metal alloys, composite materials, other types of materials, and combinations thereof. The base(s) 102 may include apertures 108-1, 108-2, 108-3, 108-4, 108-5, 108-6, 108-7, 108-N (where N is any integer greater than or equal to 1 (collectively referred to herein as aperture(s) 108 unless specifically addressed otherwise)) defined in the base(s) 102. The aperture(s) 108 may be used to couple the base(s) 102 to a subsurface located below the architectural element (FIG. 3, 304) and on which the base(s) 102 are to be seated. Specifically, fasteners such as bolts, screws, or other types of fasteners may be extended through the aperture(s) 108 and into a substrate on which the HCSA 100 are to be installed and below which the raised architectural element (FIG. 3, 304) are to be installed in order to secure the base(s) 102 to the substrate.

The base(s) 102 may further include a first retention ring 110-1, 110-2 (collectively referred to herein as first retention ring(s) 110 unless specifically addressed otherwise) defined in or formed on a top surface of each of the base(s) 102. The first retention ring(s) 110 may be used to retain a variable height coupler 104-1, 104-2 (collectively referred to herein as variable height coupler(s) 104 unless specifically addressed otherwise) in engagement with the base(s) 102. In one example, the first retention ring(s) 110 may include two concentric rings forming a first annular void 112-1, 112-2 (collectively referred to herein as first annular void(s) 112 unless specifically addressed otherwise) between the two concentric rings at which the variable height coupler(s) 104 may be engaged and seated. In one example, the first retention ring(s) 110 may engage with the variable height coupler(s) 104 via an engineering fit, an adhesive, welding, a mechanical coupling device, other coupling means, and/or combinations thereof.

The base(s) 102 may further include a central aperture 114-1, 114-2 (collectively referred to herein as central aperture(s) 114 unless specifically addressed otherwise). In one example, the central aperture(s) 114 may open into a cavity 206-1, 206-2 (collectively referred to herein as cavity(ies) 206 unless specifically addressed otherwise) defined in an underside of the base(s) 102. In one example, the cavity(ies) 206 may be used to allow for a sealant or similar material to be introduced into the cavity(ies) 206 to seal the base(s) and any fasteners extended through the aperture(s) 108 into the substrate to which the base(s) 102 are coupled.

The variable height coupler(s) may be coupled between the base(s) 102 and a rail 106. In the examples described herein, the variable height coupler(s) 104 is depicted as a spring. However, the variable height coupler(s) 104 may include any device that forces separation between the base(s) 102 and the rail 106. This bias force causes the base(s) 102 to push away from rail 106, and, in turn, causes the rail 106 to force the device (FIG. 3, 306) against an underside of the architectural element (FIG. 3, 304). The variable height coupler(s) 104 may include a spring, a pneumatic piston, a hydraulic piston, a magnet, a mechanical device such as a lever arm biased in a first direction and that yields when a force is meant, other types of devices used to bias the increase of the distance between the base(s) 102 and the rail 106, and combinations thereof. In other words, the variable height coupler(s) 104 may include any device that causes the distance between the base(s) 102 and the rail 106 to be biased to increase such that the rail 106 is able to force the device (FIG. 3, 306) towards and/or to abut the architectural element (FIG. 3, 304) and may utilize any force such as, for example, a mechanical force, a pneumatic force, a hydraulic force, a magnetic force, other types of forces and combination thereof.

In an example where the variable height coupler(s) 104 is/are a spring as depicted throughout FIGS. 1 through 13, the spring may have any length that allows for the distance between the base(s) 102 and the rail 106 to be variable. For example, the distance between the subsurface underneath the architectural element (FIG. 3, 304) may vary, and the length of spring(s) that are coupled to different base(s) 102 and rails 106 in this example may be varied in order to obtain a desired initial height and to ensure that the spring(s) are long enough to provide the biasing force against the bottom side of the architectural element (FIG. 3, 304). For example, the springs in these examples may have lengths such as 0.25 in., 0.5, in., 0.75 in., 1.0 in., 2.0 in., 3.0 in., 4.0 in., 5.0 in., 6.0 in., 7.0 in., 8.0 in., 9.0 in., 10.0 in., 11.0 in., 12.0 in., and length between these examples, and any length in general. Further, the spring(s) may be made of any material and any gauge of that material in order to provide the biasing force against the underside of the architectural element (FIG. 3, 304).

The variable height coupler(s) 104 may be coupled to the rail 106. The rail 106 may be made of any material that may support the pressures and forces applied by the base(s) 102 and variable height coupler(s) 104 as described herein. For example, the rail 106 may be made of plastics, woods, metals, metal alloys, composite materials, other types of materials, and combinations thereof. The rail 106 may include a second retention ring 202-1, 202-2 (collectively referred to herein as second retention ring(s) 202 unless specifically addressed otherwise) defined in or formed on a bottom surface of the rail 106. The second retention ring(s) 202 may be used to retain a variable height coupler 104 in engagement with the rail 106 in a manner similar to how the variable height coupler 104 engages with the base(s) 102. In one example, the second retention ring(s) 202 may include two concentric rings forming a second annular void 204-1, 204-2 (collectively referred to herein as second annular void(s) 204 unless specifically addressed otherwise) between the two concentric rings at which the variable height coupler(s) 104 may be engaged and seated. In one example, the second retention ring(s) 202 may engage with the variable height coupler(s) 104 via an engineering fit, an adhesive, welding, a mechanical coupling device, other coupling means, and/or combinations thereof.

The rail 106 may include at least one slot 116-1, 116-2, 116-3, 116-4, 116-5, 116-6, 116-7, 116-8, 116-9, 116-10, 116-11, 116-N (where N is any integer greater than or equal to 1 (collectively referred to herein as slot(s) 116 unless specifically addressed otherwise)) defined in the rail 106. The slot(s) 116 may be shaped or dimensioned to fit portions of the device (FIG. 3, 306). As mentioned above, the device (FIG. 3, 306) may include a heating element. The heating element may include, for example, at least one trace heating element used to maintain or raise the temperature of the architectural element (FIG. 3, 304) that the heating elements are positioned next to or abut. At least one device (FIG. 3, 306) (e.g., a heating element) may be inserted into the slot(s) 116. Further, at least one of the slot(s) 116 may be used to secure the device (FIG. 3, 306). In one example, a plurality of slot(s) 116 may be used to support the device (FIG. 3, 306) or a plurality of devices (FIG. 3, 306). In one example, the slot(s) 116 may be formed in the rail 106 such that the slot(s) 116 have a generally u-shaped cross-section. However, the slot(s) 116 may have any shape or dimension including a shape that may accommodate the shape and dimensions of the device (FIG. 3, 306).

The rail 106 may further include at least one retention catch 118-1, 118-2, 118-3, 118-4, 118-5, 118-6, 118-7, 118-8, 118-9, 118-10, 118-11, 118-N (where N is any integer greater than or equal to 1 (collectively referred to herein as retention catch(es) 118 unless specifically addressed otherwise)) formed on an interior portion of the slot(s) 116. In one example, the retention catch(es) 118 The retention catches 118 may assist in securing the device (FIG. 3, 306) (e.g., a heating element) within the slot(s) 116 in order to maintain the device (FIG. 3, 306) in a secured state with the rail 106. In one example, the retention catch(es) 118 may be formed on a side of the slot(s) 116. When in use, at least one device (FIG. 3, 306) (e.g., a heating element) may be inserted in at least one of the slot(s) 116 with a surface of the device (FIG. 3, 306) being pushed past the retention catch(es) 118 such that the retention catch(es) 118 increase the engineering fit between the retention catch(es) 118 and the device (FIG. 3, 306) relative to the engineering fit between the slot(s) 116 and the device (FIG. 3, 306). In other words, the engineering fit between the slot(s) 116 and the device (FIG. 3, 306) when the device (FIG. 3, 306) is inserted into the slot(s) 116 may be a relatively looser engineering fit as compared to the engineering fit between the retention catch(es) 118 and the device (FIG. 3, 306) when the device (FIG. 3, 306) is inserted into the slot(s) 116. In this manner, the retention catch(es) 118 may serve to retain the device (FIG. 3, 306) in engagement with the rail 106. More details regarding the interaction between the slot(S) 116, the retention catch(es) 118, and the device (FIG. 3, 306) are provided below.

As indicated in FIG. 1, the rail 106 may have a width designated by “W” and a length designated by “L.” The rail 106 may have a width W greater or less than those depicted and described and a length L greater or less than those depicted and described. As to the length L of the rail 106, a rail 106 having a relatively shorter length L may include fewer slot(s) 116 and/or retention catch(es) 118 and a rail 106 having a relatively longer length L may include more slot(s) 116 and/or retention catch(es) 118. The rail 106 may further include a height designated by “H.” The height H may be defined by the size of a device (FIG. 3, 306) that is to be seated with in the slot(s) 116 of the rail while providing for material of the rail 106 to back the slot(s) 116.

A rail 106 having a relatively shorter width W may include fewer retention catch(es) 118 and a rail 106 having a relatively longer width W may include more retention catch(es) 118. In one example, the width W of the rail 106 in FIGS. 1 through 7 may be between 0.5 in. (e.g., 12.7 mm) and 1.5 in. (e.g., 38.1 mm). In one example, the width W of the rail 106 in FIGS. 1 through 7 may be approximately 1.0 in. (25.4 mm). In one example, the length L of the rail 106 in FIGS. 1 through 7 may be between 1 in. (e.g., 254 mm) and 36 in. (e.g., 914.4 mm). In one example, the length L of the rail 106 in FIGS. 1 through 7 may be 12 in. (e.g., 304.8 mm). In one example, the height H of the rail 106 in FIGS. 1 through 7 may be between 0.2 in. (e.g., 5.08 mm) and 1.5 in. (e.g., 38.1 mm). In one example, the height H of the rail 106 in FIGS. 1 through 7 may be 0.55 in. (e.g., 13.97 mm).

Again, although two bases 102 are depicted in FIGS. 1 through 10, any number of base(s) 102 may be included and the elements of the HCSA 100 described herein that are associated with the addition of base(s) 102 may also be included. With the addition or subtraction of base(s) 102, a corresponding number of variable height coupler(s) 104 may be included. Further, with the addition or subtraction of base(s) 102, a corresponding number of second retention ring(s) 202 and/or second annular void(s) 204 may be defined or formed on the underside of the rail 106.

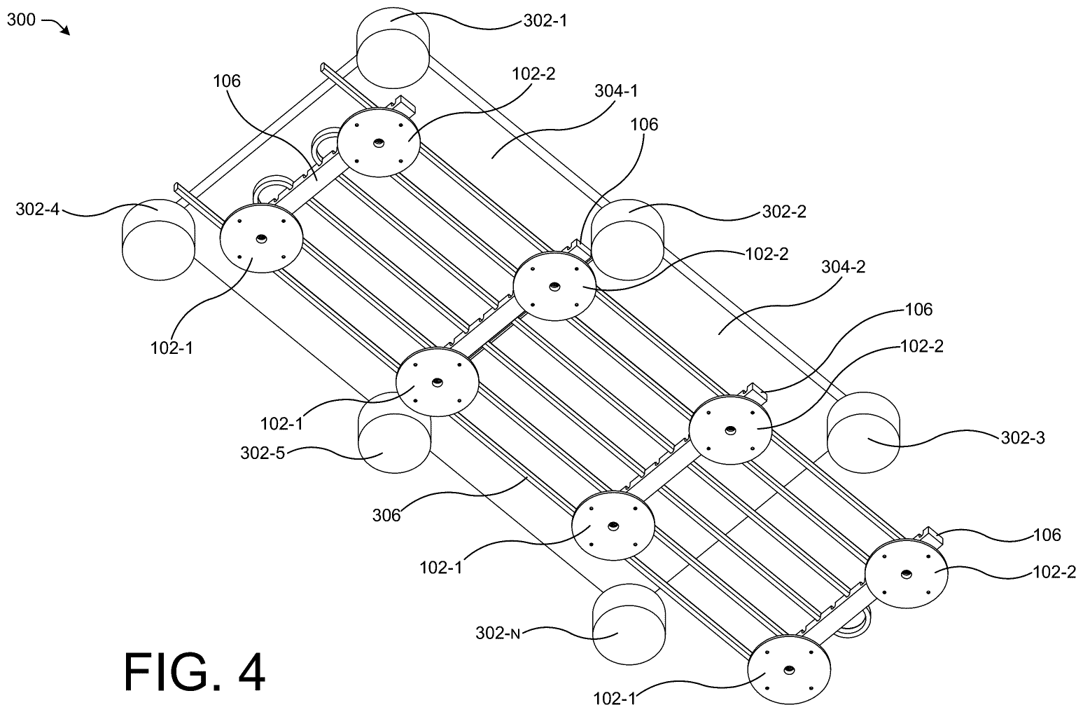

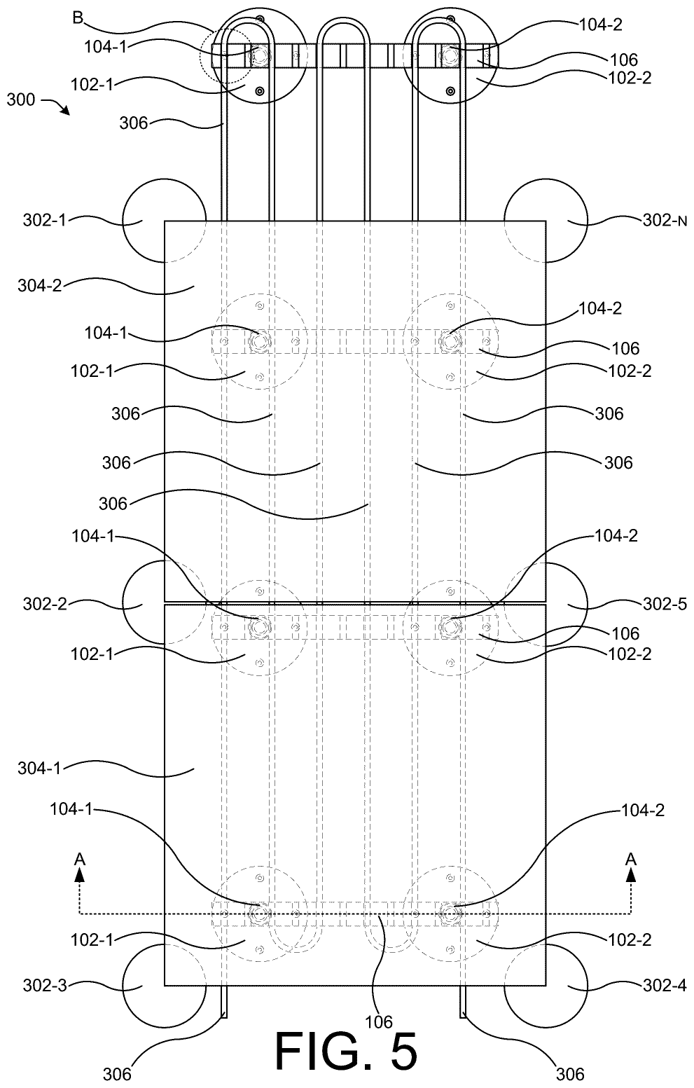

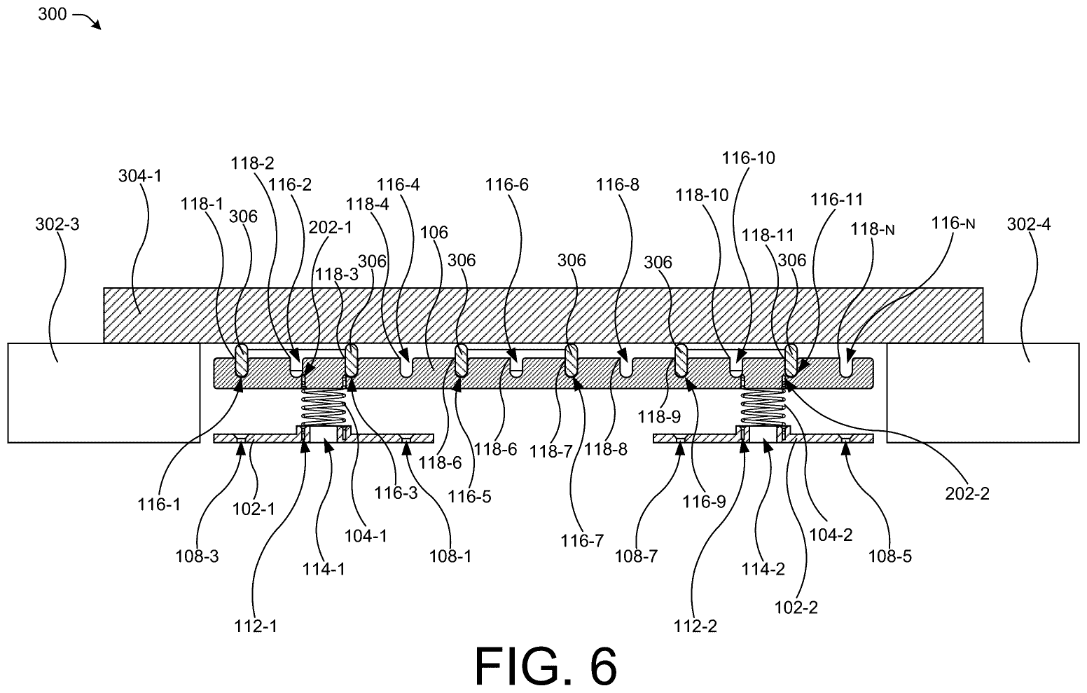

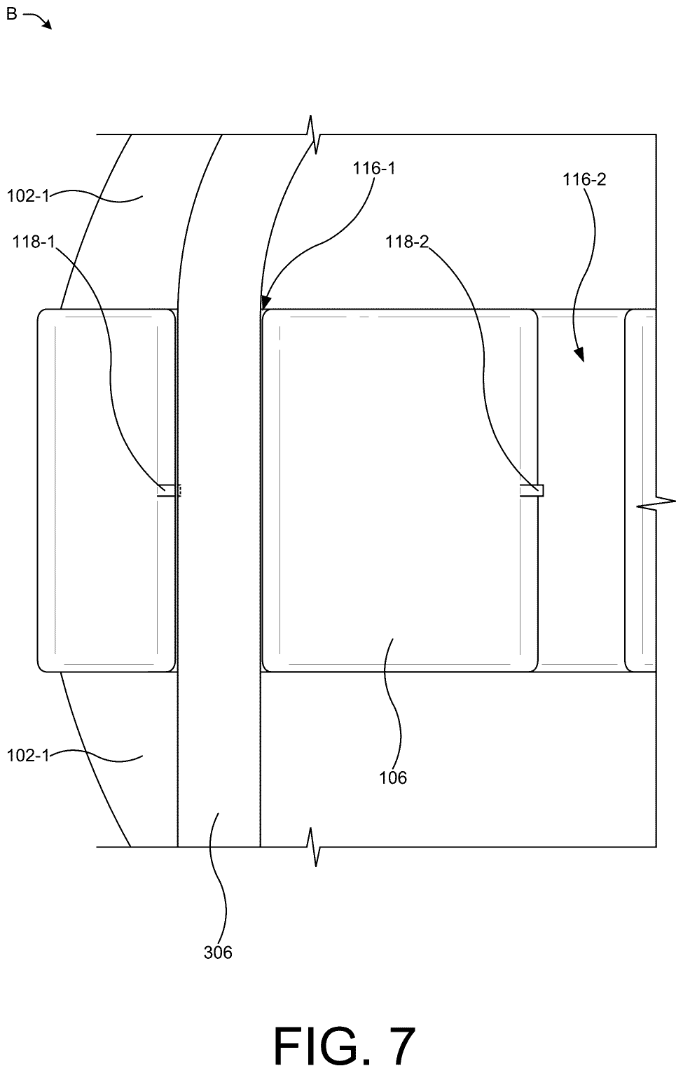

Having described the HCSA 100 in connection with FIGS. 1 and 2, the application of the HCSA 100 will now be described in connection with FIGS. 3 through 7. To this end, FIG. 3 illustrates a top perspective view of a paver system 300 incorporating the HCSA 100 of FIGS. 1 and 2, according to an example of the principles described herein. FIG. 4 illustrates a bottom perspective view of the paver system 300 incorporating the HCSA 100 of FIGS. 1 and 2, according to an example of the principles described herein. FIG. 5 illustrates a top plan view of the paver system 300 incorporating the HCSA 100 of FIGS. 1 and 2, according to an example of the principles described herein. FIG. 6 illustrates a cutaway side view of the paver system 300 about the line A of FIG. 4, according to an example of the principles described herein. FIG. 7 illustrates a cutaway view of the paver system 300 about the circle B of FIG. 4, according to an example of the principles described herein. As mentioned above, the HCSA 100 of FIGS. 1 and 2 may be placed underneath raised surface elements such as pavers or tiles. The raised surface elements may be used to allow for electrical wiring, pipes, heating, ventilation, and air conditioning (HVAC) systems and other utilities to be incorporated underneath the overlaying the surface(s) of walkable areas created by the raised surface elements. In the examples described herein, the utilities used in connection with the HCSA 100 and the paver system 300 includes a device 306 such as a heating element that may be used to conduct heat to a paver 304-1, 304-2 (collectively referred to herein as paver(s) 304 unless specifically addressed otherwise) when placed juxtaposition to or abutting the paver(s) 304. Consequently, the conducted heat provided by the device 306 may cause precipitation such as snow or rain, or deposited ice to melt and/or evaporate from the top surface of the paver(s) 304 and create a relatively safer surface on which a user may walk or drive an automobile.

Thus, the paver system 300 may include at least one stanchion 302-1, 302-2, 302-3, 302-4, 302-5, 302-N (where N is any integer greater than or equal to 1 (collectively referred to herein as stanchion(s) 302 unless specifically addressed otherwise)) upon which a paver 304-1, 304-N (where N is any integer greater than or equal to 1 (collectively referred to herein as paver(s) 304 unless specifically addressed otherwise)) may be placed. The stanchion(s) 302 may be of any height as needed to raise the elevation of the paver(s) 304 above a subsurface or substructure. Further, the stanchion(s) 302 may be configured to interface with the paver(s) 304 in order to ensure that the paver(s) 304 do not shift or move once installed.

As depicted in FIGS. 3 through 7, the device 306 may be installed in the slot(s) 116 of the rails 106 of a plurality of HCSAs 100. In one example, the plurality of HCSAs 100 may be located underneath a plurality of pavers 304 and the device 306 may be engaged within at least one slot 116 of the rails 106 of a plurality of HCSAs 100 in order to allow for the device 306 to extend along a length of the plurality of pavers 304 while being supported and held against the bottom side of the pavers 304 by the plurality of HCSAs 100. Further, in one example, the device 306 may be extended back and forth across a plurality of HCSAs 100 such that the device 306 engages with a plurality of slots 116 of the rails 106 of the plurality of HCSAs 100 with the device 306 seating within the slots 116 in opposite directions along the length L of the rails 106. Together, the plurality of HCSAs 100 may force the device 306 toward the bottom side of the pavers 304, and, as described herein, in juxtaposition with or abutting the pavers 304.

Specifically, as depicted in FIGS. 5 and 6 at line A of FIG. 5, the device 306 may be a single length of a heating element that may be seated in slots 116-1, 116-3, 116-5, 116-7, 116-9, and 116-11 of each of the HCSAs 100 included within the paver system 300. The ends of the device 306 may be coupled to an electricity source for use in generating heat to, in turn, transfer to the paver(s) 304 through thermal conductivity. Although the device 306 is depicted in FIGS. 3 through 7 as being seated in slots 116-1, 116-3, 116-5, 116-7, 116-9, and 116-11, the device 306 may be seated in any of the slot(s) 116 as may fit a particular application or assembly. Stated another way, the number of slot(s) 116 defined in the rail 106 may be plural to allow for different configurations and spacing of portions of the device 306, to allow for different configurations and spacing of a plurality of devices 306, and combinations thereof.

With reference to FIG. 7 and the cutaway view of the paver system about circle B of FIG. 4, the device 306 is depicted as engaged with, for example, slot 116-1. The device 305 may be secured within the slot 116-1 via the retention catch 118-1 that causes additional pressure between the rail 106 and the device 306. As described above, the retention catch(es) 118 increase the engineering fit between the retention catch(es) 118 and the device 306 relative to the engineering fit between the remaining portions of the slot(s) 116 and the device 306. In other words, the engineering fit between the slot(s) 116 and the device 306 when the device 306 is inserted into the slot(s) 116 may be a relatively looser engineering fit as compared to the engineering fit between the retention catch(es) 118 and the device 306 when the device 306 is inserted into the slot(s) 116. In this manner, the retention catch(es) 118 may serve to retain the device (FIG. 3, 306) in engagement with the rail 106. In one example, the device 306 may include a rubber or plastic cladding on the outside having a coefficient of friction (F_{f}) (e.g., static friction) that causes the device 306 to be retained within the slot(s) 116. The retention catch(es) 118 may further increase the effects of the coefficient of friction (F_{f}) of the device 306 with respect to the rail 106 by increasing the normal force as indicated in the below equation of the coefficient of friction (F_{f}):

$${F}_{f} = μ {F}_{n} \qquad Eq . 1$$

where F_{f} is the frictional force, μ is the coefficient of friction, and Fₙ is the normal force. Because the retention catch(es) 118 protrude into the slot(s) 116 and are relatively closer to the device 306 than the remaining portions of the slot(s) 116 and/or protrude into the surface of the device 306 relatively more so as compared to the remaining portions of the slot(s) 116, the retention catch(es) 118 are capable of retaining the device 306 within the slot(s) 116. Although the retention catch(es) 118 are described herein as the means by which the device 306 is retained within the slot(s) 116, any mechanical means may be used to retain the device 306 within the slot(s) 116.

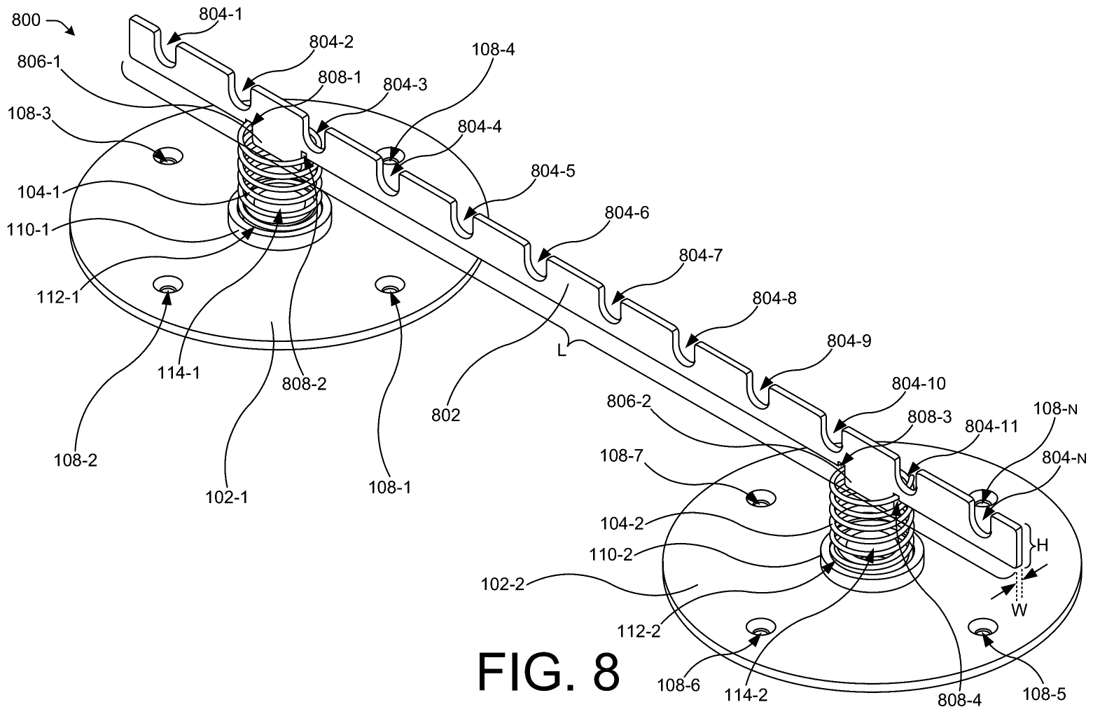

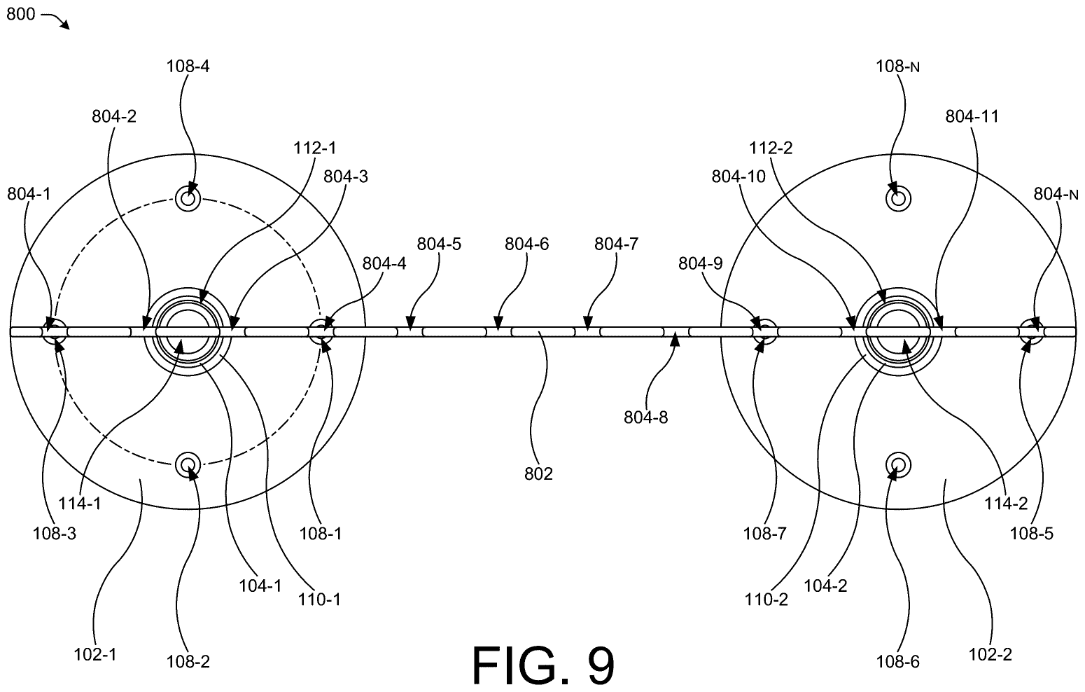

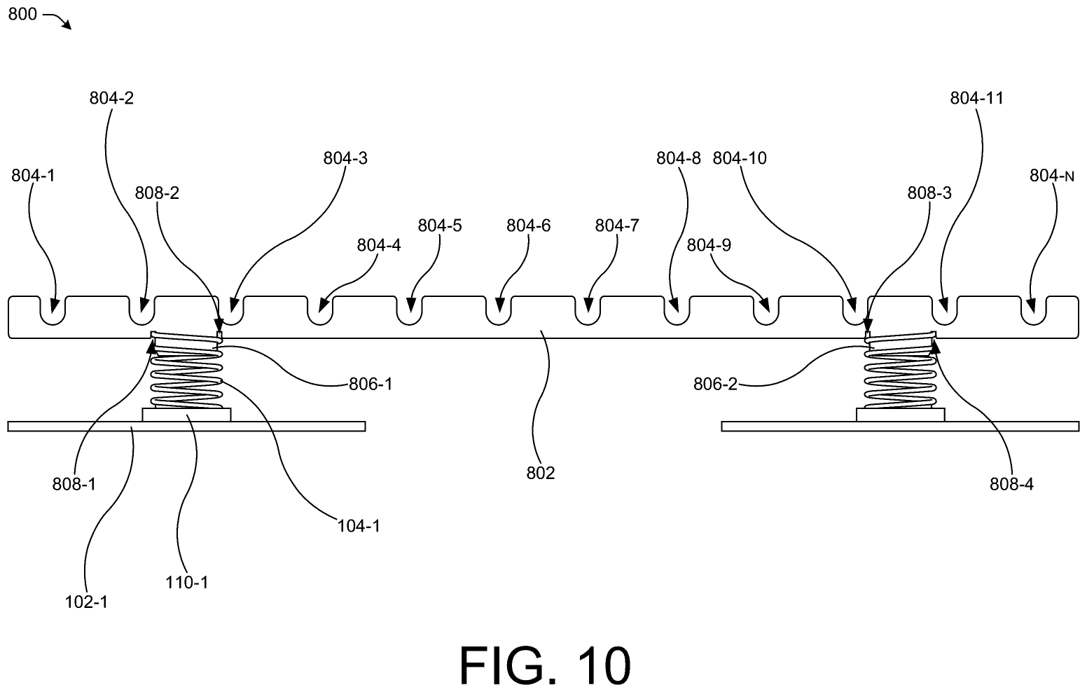

Turning now to additional examples of the HCSA 100, FIG. 8 illustrates a top perspective view of a HCSA 800, according to an example of the principles described herein. FIG. 9 illustrates a top plan view of the HCSA 800 of FIG. 8, according to an example of the principles described herein. FIG. 10 illustrates a side plan view of the HCSA 800 of FIG. 8, according to an example of the principles described herein. As depicted in FIGS. 8 through 10, the base(s) 102, may be coupled to the variable height coupler(s) 104 as described above in connection with FIGS. 1 through 7. However, the rail 802 of FIGS. 8 through 10 may differ from the rail 106 of FIGS. 1 through 7. For example, the rail 802 of FIGS. 8 through 10 may include a length L that is similar to the example lengths L of the rail 106 of FIGS. 1 through 7. The rail 802 of FIGS. 8 through 10 may, however, have a shorter width W as compared to the width W of the rail 106 of FIGS. 1 through 7. In the example of FIGS. 8 through 10, the width W of the rail 802 may be between 0.02 in. (e.g., 0.508 mm) and 0.5 in. (e.g., 12.7 mm). In one example, the width W of the rail 802 may be approximately 0.05 in. (e.g., 1.27 mm). In one example, the rail 802 of FIGS. 8 through 10 may include a height H that is similar to the example heights H of the rail 106 of FIGS. 1 through 7. For example, the rail 802 of FIGS. 8 through 10 may include a height H of between 0.2 in. (e.g., 5.08 mm) and 1.5 in. (e.g., 38.1 mm). In one example, the height H of the rail 802 may be 0.55 in. (e.g., 13.97 mm).

In a similar manner to the rail 106 of FIGS. 1 through 7, the rail 802 of FIGS. 8 through 10 may be made of any material that may support the pressures and forces applied by the base(s) 102 and variable height coupler(s) 104 as described herein. For example, the rail 802 may be made of plastics, woods, metals, metal alloys, composite materials, other types of materials, and combinations thereof.

The rail 802 may further include at least one protrusion 806-1, 806-2 (collectively referred to herein as protrusion(s) 806 unless specifically addressed otherwise) formed on a bottom side of the rail 802. Further, in conjunction with the protrusion(s) 806, voids 808-1, 808-2, 808-3, 808-4 (collectively referred to herein as void(s) 808 unless specifically addressed otherwise) may be defined in the bottom of the rail 802. The protrusion(s) 806 and the void(s) 808 may be used to couple the variable height coupler(s) 104 to the rail 802. Specifically, the protrusion(s) 806 provide a portion of the rail 802 that the variable height coupler(s) 104 (e.g., a spring) may couple to via an engineering fit, an adhesive, welding, a mechanical coupling device, other coupling means, and/or combinations thereof. Further, the void(s) 808 may serve to provide a portion within the rail 802 where the ends of the variable height coupler(s) 104 may be seated and engage with the rail 802.

The rail 802, like the rail 106 of FIGS. 1 through 7, may include at least one slot 804-1, 804-2, 804-3, 804-4, 804-5, 804-6, 804-7, 804-8, 804-9, 804-10, 804-11, 804-N (where N is any integer greater than or equal to 1 (collectively referred to herein as slot(s) 804 unless specifically addressed otherwise)) defined in the rail 802. The slot(s) 804 may be shaped or dimensioned to fit portions of the device 306 in a manner similar to that described herein. In one example, the slot(s) 804 may include a feature similar or identical to the retention catch(es) 118. In this example, the retention catch(es) 118 may be formed on one side of the slot(s) 804 since the width of the retention catch(es) 118 may be approximately the same width W of the rail 802. The remainder of the elements of the HCSA 800 such as the aperture(s) 108, the first retention ring(s) 110, the first annular void(s) 112, and the central aperture(s) 114 of the base(s) 102 may be included in the HCSA 800 of FIGS. 8 through 10 and the description of these elements are provided herein.

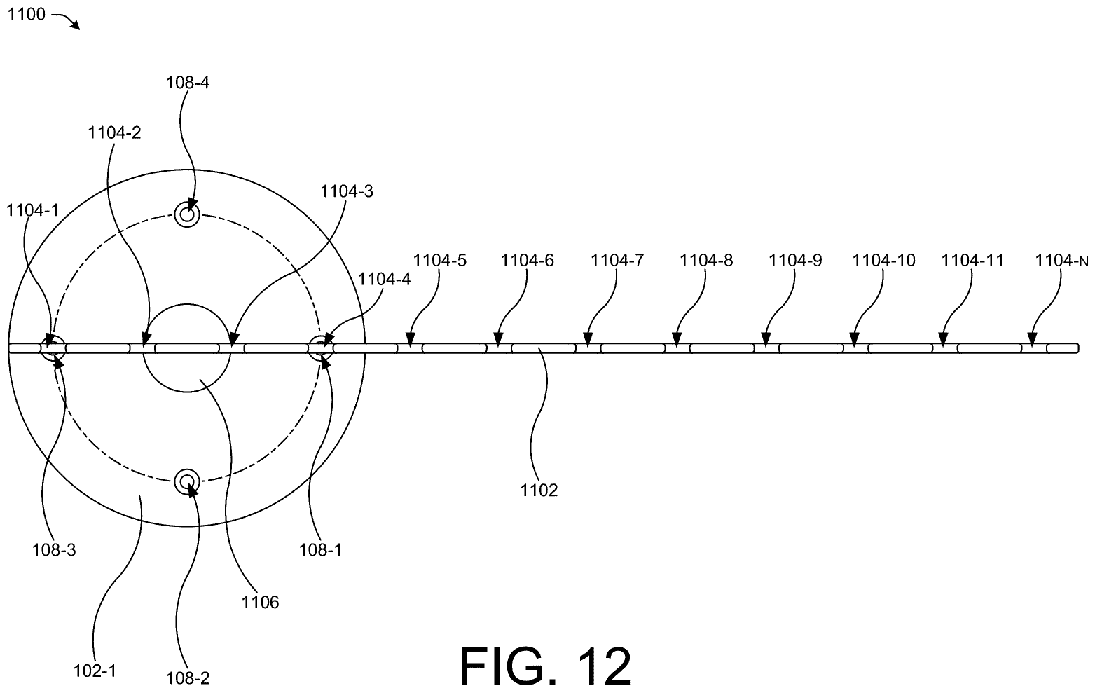

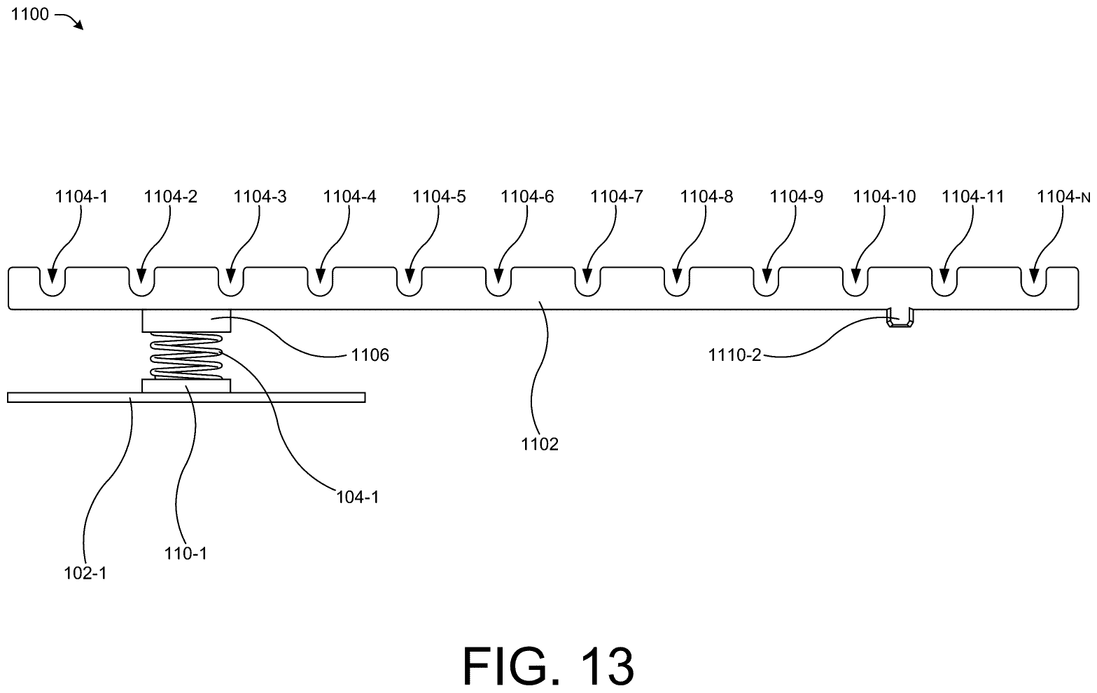

Turning now to another additional example of the HCSAs 100, 800 FIG. 11 illustrates a top perspective view of a HCSA 1100, according to an example of the principles described herein. FIG. 12 illustrates a top plan view of the HCSA 1100 of FIG. 11, according to an example of the principles described herein. FIG. 13 illustrates a side plan view of the HCSA 1100 of FIG. 11, according to an example of the principles described herein. As depicted in FIGS. 11 through 13, the base(s) 102, may be coupled to the variable height coupler(s) 104 as described above in connection with FIGS. 1 through 10. However, the rail 1102 of FIGS. 11 through 13 may differ from the rail 106 of FIGS. 1 through 7 and/or the rail 802 of FIGS. 8 through 10. For example, the rail 1102 of FIGS. 11 through 13 may include a length L that is similar to the example lengths L of the rail 106 of FIGS. 1 through 7 and/or the rail 802 of FIGS. 8 through 10. The rail 802 of FIGS. 11 through 13 may, however, have a shorter width W as compared to the width W of the rail 106 of FIGS. 1 through 7. In the example of FIGS. 11 through 13, the width W of the rail 802 may be between 0.02 in. (e.g., 0.508 mm) and 0.5 in. (e.g., 12.7 mm). In one example, the width W of the rail 802 may be approximately 0.05 in. (e.g., 1.27 mm). In one example, the rail 1102 of FIGS. 11 through 13 may include a height H that is similar to the example heights H of the rail 106 of FIGS. 1 through 7 and/or the rail 802 of FIGS. 8 through 10. For example, the rail 1102 of FIGS. 11 through 13 may include a height H of between 0.2 in. (e.g., 5.08 mm) and 1.5 in. (e.g., 38.1 mm). In one example, the height H of the rail 802 may be 0.55 in. (e.g., 13.97 mm).

In a similar manner to the rail 106 of FIGS. 1 through 7 and/or the rail 802 of FIGS. 8 through 10, the rail 1102 of FIGS. 11 through 13 may be made of any material that may support the pressures and forces applied by the base(s) 102 and variable height coupler(s) 104 as described herein. For example, the rail 802 may be made of plastics, woods, metals, metal alloys, composite materials, other types of materials, and combinations thereof.

The rail 1102 may further include at least one protrusion 1110-1, 1110-2 (collectively referred to herein as protrusion(s) 1110 unless specifically addressed otherwise) formed on a bottom side of the rail 1102. In one example, the protrusion(s) 1110 may be similar to the protrusion(s) 806 of FIGS. 8 through 10 but may be relatively smaller than the protrusion(s) 806 of FIGS. 8 through 10. Further, the rail 1102 may include a coupler interface 1106 to assist in coupling the variable height coupler(s) 104. A depiction of the protrusion(s) 1110 is provided in FIGS. 11 through 13 by removing one of the base(s) 102 such as a second base 102-2 (not shown in FIGS. 11 through 13). Although the HCSA 1100 is depicted with a single base 102 (e.g., a first base 102-1) and may be utilized without a second base 102 (e.g., the second base 102-2), the second base 102 is not depicted in order to more effectively portray the protrusion(s) 1110.

A slit 1108 may be defined in a top surface of the coupler interface 1106. The slit 1108 may be dimensioned to allow the protrusion(s) 1110 to be inserted into the slit 1108 and allow a bottom surface of the rail 1102 to sit on the top surface of the coupler interface 1106. In this manner, the coupler interface 1106 and the protrusion(s) 1110 may be coupled to one another. In one example, the coupler interface 1106 may further include a circular internal void into which the variable height coupler(s) 104 may be seated. In one example, the engagement between the variable height coupler(s) 104 and the coupler interface 1106 and the interface between the coupler interface 1106 and the protrusion(s) 1110 may be accomplished via an engineering fit, an adhesive, welding, a mechanical coupling device, other coupling means, and/or combinations thereof. In this manner, the coupler interface 1106 and the protrusion(s) 1110 of the rail 1102 serve to couple the base(s) 102, the variable height coupler(s) 104, and the rail 1102 to one another.

The rail 1102, like the rail 106 of FIGS. 1 through 7 and/or the rail 802 of FIGS. 8 through 10, may include at least one slot 1104-1, 1104-2, 1104-3, 1104-4, 1104-5, 1104-6, 1104-7, 1104-8, 1104-9, 1104-10, 1104-11, 1104-N (where N is any integer greater than or equal to 1 (collectively referred to herein as slot(s) 1104 unless specifically addressed otherwise)) defined in the rail 1102. The slot(s) 1104 may be shaped or dimensioned to fit portions of the device 306 in a manner similar to that described herein. In one example, the slot(s) 1104 may include a feature similar or identical to the retention catch(es) 118. In this example, the retention catch(es) 118 may be formed on one side of the slot(s) 1104 since the width of the retention catch(es) 118 may be approximately the same width W of the rail 1102. The remainder of the elements of the HCSA 1100 such as the aperture(s) 108, the first retention ring(s) 110, the first annular void(s) 112, and the central aperture(s) 114 of the base(s) 102 may be included in the HCSA 1100 of FIGS. 11 through 13 and the description of these elements are provided herein.

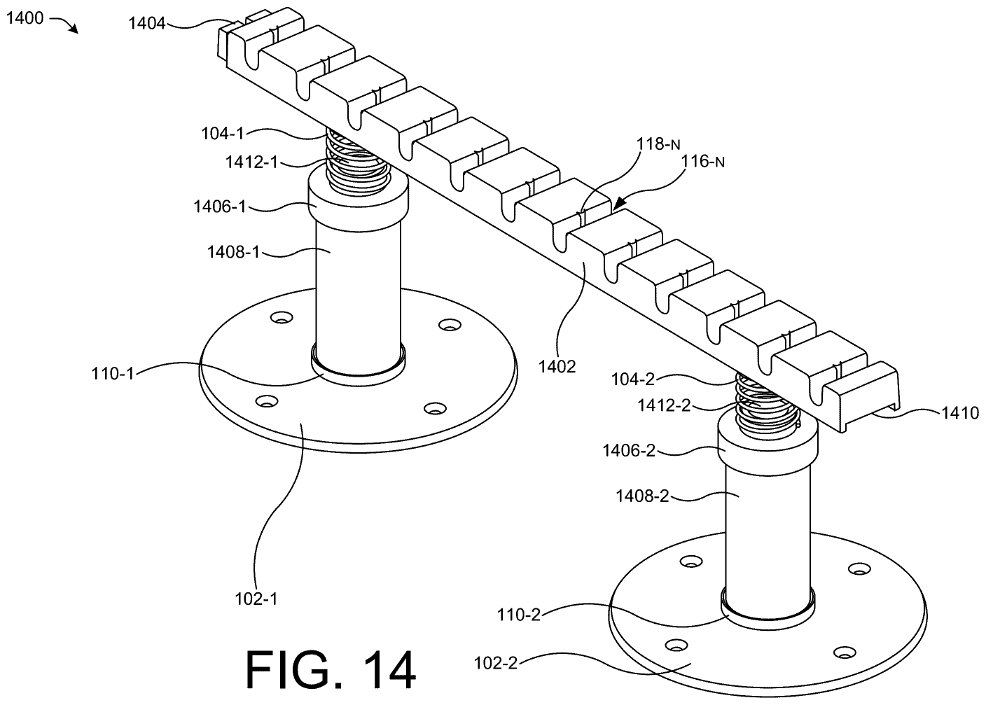

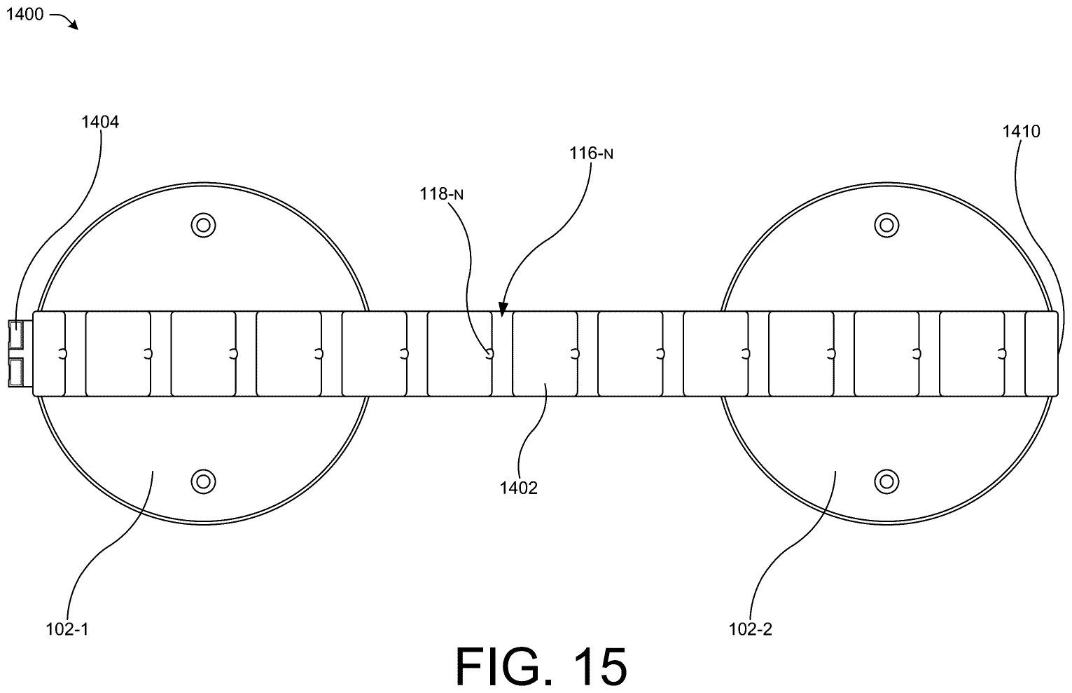

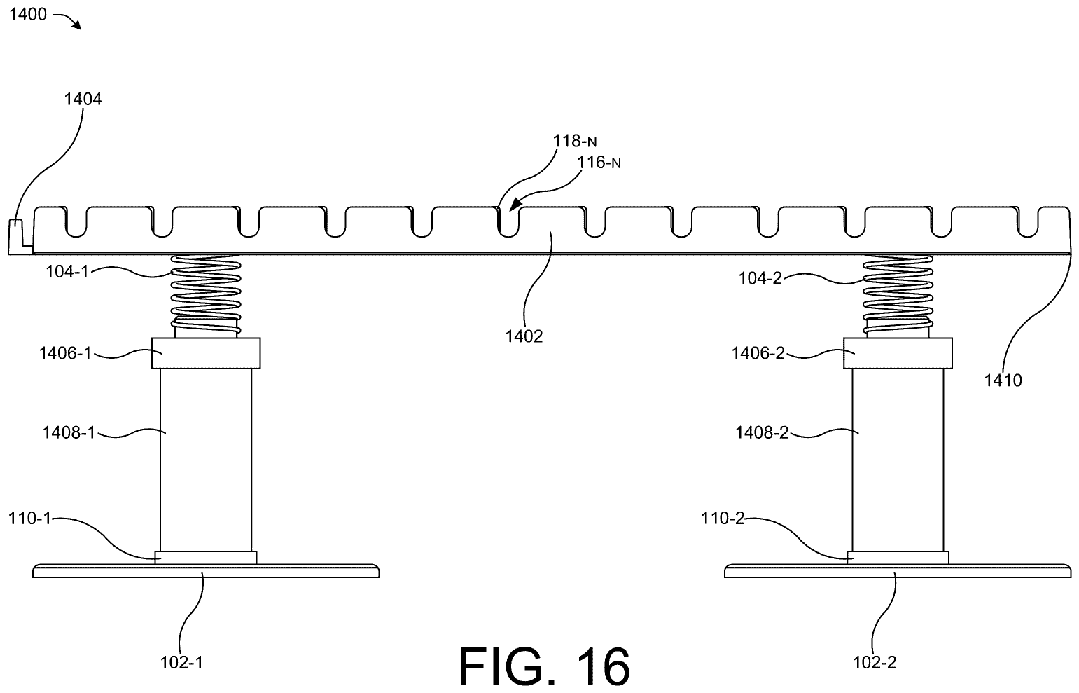

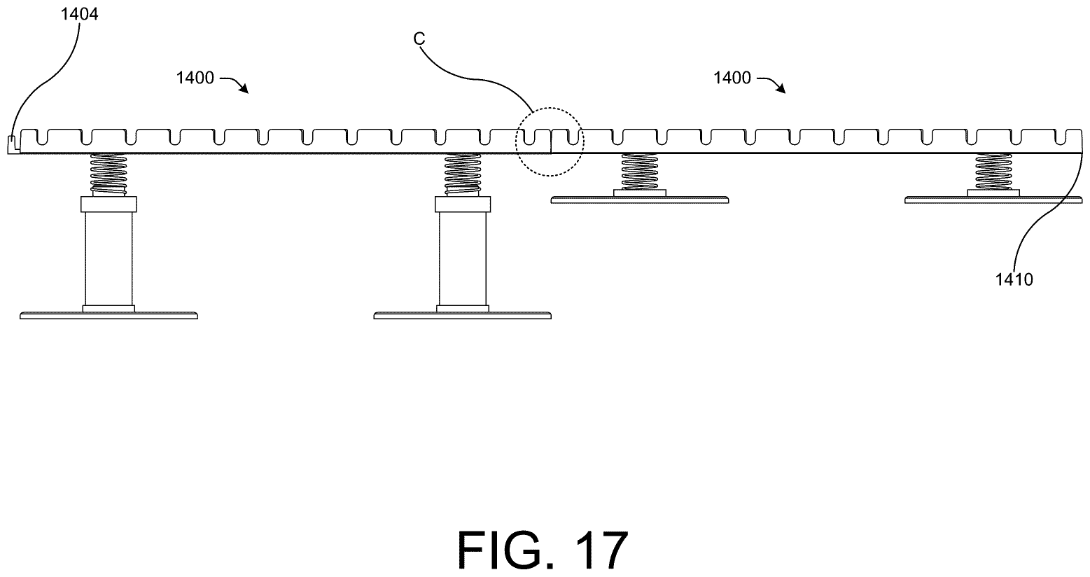

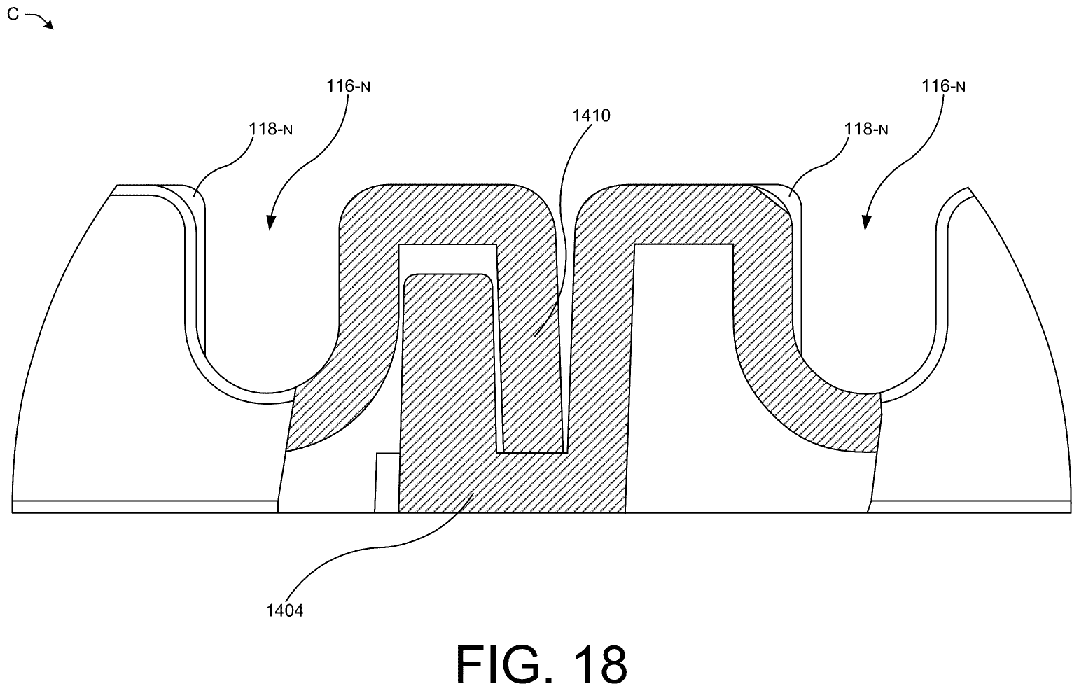

FIG. 14 illustrates a top perspective view of a HCSA 1400, according to an example of the principles described herein. FIG. 15 illustrates a top plan view of the HCSA 1400 of FIG. 14, according to an example of the principles described herein. FIG. 16 illustrates a side plan view of the HCSA 1400 of FIG. 14, according to an example of the principles described herein. FIG. 17 illustrates a side plan view of two of the HCSAs 1400 of FIG. 14 coupled together, according to an example of the principles described herein. FIG. 18 illustrates a cutaway view of the two HCSAs 1400 of FIG. 17 about the circle C of FIG. 17, according to an example of the principles described herein. The HCSA 1400 of FIG. 14 may include elements of the example HCSA 100, 800, 1100 of FIGS. 1 through 13 including the base(s) 102 and the variable height coupler(s) 104 and the respective constituent elements thereof.

The HCSA 1400 of FIGS. 14 through 16 may include a rail 1402. The rail 1402 may include slot(s) 116 (generally designated in FIGS. 14-18 as 116-N) and retention catch(es) 118 (generally designated in FIGS. 14-18 as 118-N) as similarly described herein in connection with the example HCSAs 100, 800, 1100 of FIGS. 1 through 13. The rail 1402 may further include a first coupler 1404 formed on a first end of the rail 1402 and a second coupler 1410 formed on a second end of the rail 1402.

In one example, the first coupler 1404 may include a linear clip that extends from the body of the rail 1402 and may be referred to as the male coupling element of the first coupler 1404 and the second coupler 1410. The second coupler 1410 may include a coupler void defined in a side and the second end of the rail 1402 into which the first coupler 1404 may nest and may be referred to as the female coupling element of the first coupler 1404 and the second coupler 1410. More regarding the first coupler 1404 and the second coupler 1410 is described herein.

The HCSA 1400 may further include a tube 1408-1, 1408-2 (collectively referred to herein as tube(s) 1408 unless specifically addressed otherwise) and tube mounts 1406-1, 1406-2 (collectively referred to herein as tube mount(s) 1406 unless specifically addressed otherwise). The tube(s) 1408 may include any dimension of pipe and may be made of any material. Further, the tube(s) 1408 may have any length or may be cut by a user at a specific length to fit a particular application or situation. In one example, the tube(s) 1408 may be schedule 40 polyvinyl chloride (PVC) piping, schedule 80 PVC piping, schedule 40 acrylonitrile-butadiene-styrene (ABS) piping, schedule 80 ABS piping, and other types of piping. In one example, the tube(s) 1408 may be sold separately from the remainder of the elements of the HCSAs 100, 800, 1100, 1400 described herein. In this example, a user such as an installer of the HCSAs 100, 800, 1100, 1400 may acquire piping for the tube(s) 1408 from a separate source and cut the tube(s) to length as required for the particular application or situation.

The tube(s) 1408 may be dimensioned to fit into the first retention ring(s) 110 of the base(s) 102 via an engineering fit. In this manner, instead of the variable height coupler(s) 104 interfacing with the first retention ring(s) 110, the tube(s) 1408 may interface with the first retention ring(s) 110 to provide an extended distance between the base(s) 102 and the variable height coupler(s) 104 in situations where longer variable height coupler(s) 104 may not be able to reach the distance between the subsurface or substructure and the bottom of the paver(s) 304. In one example, having relatively longer variable height coupler(s) 104 may create instability in the HCSAs 100, 800, 1100, 1400 such that the ability of the HCSAs 100, 800, 1100, 1400 to apply the biasing force provided by the variable height coupler(s) 104 to the bottom of the paver(s) 304 may be compromised. Thus, in this scenario, the tube(s) 1408 may be included and dimensioned such that the length of the variable height coupler(s) 104 may be reduced and allow the relatively shorter variable height coupler(s) 104 to work effectively in applying the biasing force.

In association with the tube(s) 1408, the tube mount(s) 1406 may couple the tube(s) 1408 to the variable height coupler(s) 104. The tube mount(s) 1406 may include an interior diameter dimensioned to fit around the top of the tube(s) 1408 via an engineering fit to couple the tube(s) 1408 to the tube mount(s) 1406. The tube mount(s) 1406 may further include nodes 1412-1, 1412-2 (collectively referred to herein as node(s) 1412 unless specifically addressed otherwise) formed on the top of the tube mount(s) 1406 and protruding towards the variable height coupler(s) 104 and the rail 1402. The node(s) 1412 may be dimensioned to fit inside a diameter of the variable height coupler(s) 104 via an engineering fit to couple the tube mount(s) 1406 to the variable height coupler(s) 104. The variable height coupler(s) 104 may then be coupled to the rail 1402 as described herein in connection with the examples of FIGS. 1 through 13.

In FIG. 17, a first HCSA 1400 is depicted having tube(s) 1408 and tube mount(s) 1406 while a second HCSA 1400 is depicted without tube(s) 1408 and tube mount(s) 1406. This may be the case in situations where the subsurface or substructure beneath the paver(s) 304 is uneven or otherwise inconsistent. Further, different lengths of tube(s) 1408, different lengths of variable height coupler(s) 104, exclusion of the tube(s) 1408, and combinations thereof may be used to adjust for any differences in distances between the subsurface or substructure and the paver(s) 304. In this manner, the HCSAs 100, 800, 1100, 1400 may be used to account for any uneven subsurface or substructure and ensure that the device 306 is forced against an underside of the paver(s) 304 irrespective of the distances between the subsurface or substructure and the paver(s) 304 at any point along the area of the paver(s) 304.

Turning again to the first coupler 1404 and the second coupler 1410, as indicated in FIGS. 17 and 18, circle C depicts the manner in which two rails 1402 couple to one another. Each rail 1402 may include a first coupler 1404 formed on a first end of the rail 1402 and a second coupler 1410 formed on a second end of the rail 1402. The first coupler 1404 functioning as the male coupling element may nest inside the second coupler 1410 functioning as the female coupling element. In one example, the first coupler 1404 and the second coupler 1410 may nest together in this manner and remain coupled via an engineering fit. However, the first coupler 1404 and the second coupler 1410 may be coupled together via an engineering fit, an adhesive, welding, a mechanical coupling device, other coupling means, and/or combinations thereof. Any number of rails 1402 may be coupled together in this manner, Further, in one example, the length of the individual rails 1402 may vary to allow for intermediate lengths of coupled rails 1402 to be achieved.

As described herein, the base(s) 102, the variable height coupler(s) 104, the rails 106, 802, 1102, and/or combinations thereof may be monolithically formed. Further, the HCSA 100, 800, 1100 including the base(s) 102, the variable height coupler(s) 104, the rails 106, 802, 1102, and/or combinations thereof may be made of hard, soft, flexible, and/or ridged materials to allow for the functional aspects of the HCSA 100, 800, 1100. In one example, the base(s) 102, the variable height coupler(s) 104, the rails 106, 802, 1102, and/or combinations thereof may be permanently, non-permanently, or removably integrated. Further, the base(s) 102, the variable height coupler(s) 104, the rails 106, 802, 1102, and/or combinations thereof may be integrated including as a monolithic part made of a single part of material such as, for example, silicone or similar flexible material to allow for the variable height coupler portion of the monolithic build to function in concert with the base(s) 102 and/or the rails 106, 802, 1102.

Further, in the examples described herein, the HCSA 100, 800, 1100 may be used to support any other types of devices 306 other than the example heating element and may include any infrastructure elements such as electrical wiring, pipes, heating, ventilation, and air conditioning (HVAC) systems and other utilities and infrastructure elements. This may assist in the organization and support of these different types of infrastructure elements. Further, in one example, the HCSA 100, 800, 1100 may serve to assist in grounding electrical wiring to, for example, a metallic plate that is incorporated into, is part of, or functions as the architectural element 304. Other uses of the HCSA 100, 800, 1100 may be understood as being within the scope of the present systems and method and is not limited to the specific examples described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

### CONCLUSION

The examples described herein provide a heating cable support assembly (HCSA) for use in raised surface including architectural elements that are raised onto stanchions. The HCSA may be used to ensure direct contact or an intended juxtaposition of a device such as, for example, a heating element relative to the architectural elements such as, for example, pavers or tiles that are included within the raised surface. The HCSA may include variable height coupler(s) that are able to adjust the height of a rail of the HCSA to keep the device in contact with the architectural elements. In use, the device may be placed on top of the rail and the device is pressed into the architectural elements via the variable height coupler(s).

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A support assembly comprising:
a variable height coupler;
a base coupled to a first end of the variable height coupler; and
a rail coupled to a second end of the variable height coupler.

2. The support assembly of claim 1, wherein the variable height coupler is a spring biased to separate the base from the rail.

3. The support assembly of claim 1, wherein the variable height coupler is biased to separate the base from the rail based on at least one of a mechanical force, a pneumatic force, a hydraulic force, and a magnetic force.

4. The support assembly of claim 1, wherein the variable height coupler comprises a yielding lever arm coupled between the base and the rail.

5. The support assembly of claim 1, wherein the variable height coupler is monolithically formed with the base, the rail, or combinations thereof.

6. The support assembly of claim 1, wherein the rail comprises a slot defined therein.

7. The support assembly of claim 6, wherein the slot comprises a retention catch formed on the slot.

8. The support assembly of claim 1, further comprising an annular void defined in the base.

9. The support assembly of claim 1, further comprising a protrusion formed on the rail to couple the variable height coupler to the rail.

10. The support assembly of claim 9, further comprising a coupler interface to couple the protrusion to the variable height coupler.

11. The support assembly of claim 1, further comprising:
a first coupler formed on a first end of the support assembly; and
a second coupler formed on a second end of the support assembly.

12. The support assembly of claim 1, further comprising a tube mount to couple a tube to the variable height coupler, the tube mount comprising:
a tube interface to couple the tube mount to the tube; and
a node formed on the tube mount to couple the variable height coupler to the tube mount.

13. A paver system comprising:
a paver;
a stanchion to elevate the paver above a subsurface; and
a support assembly to maintain contact between an element and the paver, the support assembly comprising:
a variable height coupler;
a base coupled to a first end of the variable height coupler; and
a rail coupled to a second end of the variable height coupler.

14. The paver system of claim 13, wherein the element is a heating element.

15. The paver system of claim 13, variable height coupler is a spring biased to separate the base from the rail.

16. The paver system of claim 13, wherein the variable height coupler is biased to separate the base from the rail based on at least one of a mechanical force, a pneumatic force, a hydraulic force, and a magnetic force.

17. The paver system of claim 13, wherein the variable height coupler comprises a yielding lever arm coupled between the base and the rail.

18. The paver system of claim 13, wherein the variable height coupler is monolithically formed with the base, the rail, or combinations thereof.

19. The paver system of claim 13, wherein the rail comprises:
a slot defined therein; and
a retention catch formed on the slot.

20. The paver system of claim 13, further comprising a mounting hole defined in the base.

21. The paver system of claim 13, further comprising a protrusion formed on the rail to couple the variable height coupler to the rail.

22. The paver system of claim 21, further comprising a coupler interface to couple the protrusion to the variable height coupler.

23. The paver system of claim 13, further comprising:
a first coupler formed on a first end of the support assembly; and
a second coupler formed on a second end of the support assembly.

24. The paver system of claim 13, further comprising a tube mount to couple a tube to the variable height coupler, the tube mount comprising:
a tube interface to couple the tube mount to the tube; and
a node formed on the tube mount to couple the variable height coupler to the tube mount.
